(19) United States
(12) Patent Application Publication
(10) Pub. No.: US 2013/0024835 A1
(43) Pub. Date: Jan. 24, 2013

(54) SYSTEM AND METHOD FOR INTEGRATED DYNAMIC CASE MANAGEMENT

(71) Applicant: ECCENTEX CORPORATION, Culver City, CA (US)

(72) Inventors: Alex Stein, Woodland Hills, CA (US); Igor Duvidson, Studio City, CA (US); Sergiy Kazakov, Los Angeles, CA (US)

(73) Assignee: ECCENTEX CORPORATION, Culver City, CA (US)

(21) Appl. No.: 13/628,026

(22) Filed: Sep. 26, 2012

Related U.S. Application Data
(63) Continuation of application No. 13/135,074, filed on Jun. 24, 2011.

(51) Int. Cl. G06F 9/44

(52) U.S. Cl. 717/103; 717/102

(57) ABSTRACT

According to a preferred embodiment, the system comprises a configuration server, a dynamic case management (DCM) application development platform, a dynamic case management (DCM) model store, and a multitenant runtime platform. The DCM application development platform further comprises a business object builder, a rule builder, and a business process builder. The multitenant runtime platform further comprises a business data server, a rules processor, a business process server, an audit server, an alert server, and a runtime security server. According to the embodiment, the runtime platform is adapted to operate in either of a shared multitenant application deployment model and a direct multitenant application deployment model. According to a further embodiment, the system provides for integration of existing elements in a corporate infrastructure or environment.

### CROSS-REFERENCE TO RELATED APPLICATIONS

This application is a continuation-in-part of U.S. patent application Ser. No. 13/135,074, titled “SYSTEM AND METHOD FOR HOSTED DYNAMIC CASE MANAGEMENT”, which was filed on Jun. 24, 2011, the entire specification of which is incorporated herewith in its entirety.

### BACKGROUND OF THE INVENTION

1. Field of the Invention

The present invention is in the field of dynamic case management software solutions, and more particularly in the field of delivering dynamic case management platforms as a service.

2. Discussion of the State of the Art

For many years, businesses have struggled to optimize the efficiency and productivity of their internal business processes, adopting such well-known management paradigms as total quality management, lean, and six sigma. In parallel, a large number of technologies have emerged to facilitate the increasing focus on management of business processes, among these a growing number of business process management (BPM) platforms. However, these platforms have suffered from two major disadvantages that have effectively served to preclude their use in the management of many large classes of important business processes. The first disadvantage is that most BPM platforms are designed to be deployed (or at least used) by single enterprises. Generally, information technology (IT) staff of an enterprise will deploy and configure BPM applications, sometimes with the help of outside systems integrators, entirely within their own enterprise. This is a problem because many business processes naturally take place across enterprise boundaries. For example, users of mobile phones who have lost their devices will generally call the carrier from whom they have been receiving service, and the carrier will bring in a specialized insurance company that insures mobile phones, tracks fraud, and handles losses. Actual fulfillment of any approved phone replacement might be carried out by yet another enterprise, such as a handset manufacturer. All three of the enterprises cited in this example are working under the brand of, and at the behest of, the mobile carrier, yet each will generally independently manage its internal business processes. As a result, key information is often lost as a “case” (in this case, the lost mobile phone incident) migrates from one owner to another across enterprise boundaries.

The second major problem with current BPM systems is that they generally are organized around a traditional, procedural programming model in which highly technical IT staff (or systems integrators) develop BPM applications using traditional programming languages such as Java, taking advantage of special BPM application programming interfaces (API) to access services provided by BPM platforms. There are two issues resulting from this situation. First, only very technical individuals are able to make changes to BPM applications (that is, to the systems intended to automate business processes), while the people who actually manage the affected business processes are limited to writing detailed requirements and business cases, fighting for budget, and then waiting for a typically six-month change management cycle to get their changes made. Secondly, procedurally programmed BPM applications are only suitable for a subset of the major categories of business processes—those which can be explicitly defined at design time with a high degree of precision (for example, processing a loan application). Many valuable contributions have been made over the last two decades to the productivity of our economy by BPM applications despite these constraints. Unfortunately, however, many more business processes exist within enterprises that are not easily reduced to a reasonably small set of static rules that can be coded in to a BPM application.

A further limitation in existing BPM systems is limited integration with third-party applications or environments such as those used for managing logins or security credentials, access rules, or environment features such as appearance or behavior. The issue with such limited integration is that from the perspective of a user, the BPM system does not mesh well with existing infrastructure elements and the experience may be confusing or “jarring”, and also that the BPM does not incorporate existing features of the environment, causing it to appear and function as a “one size fits all” or “canned” solution, rather than tailored to the environment in which it is deployed.

What is needed is a dynamic case management platform that facilitates the management of complex, adaptive business processes—even across enterprise boundaries—and that support a highly flexible application composition model that can be configured by line-of-business staff that actually manages the underlying business processes and has the ability to create “ad hoc workflows” (AHWs), and which may be integrated within an existing environment and with currently-implemented software solutions.

### SUMMARY OF THE INVENTION

In order to meet these needs, the inventor has conceived a dynamic case management system intended for operation in the cloud (for example, as a web-based service) that supports an easy-to-use, flexible dynamic case management application composition paradigm utilizing an underlying application library, which may integrate with third-party applications. According to a preferred embodiment, the system comprises a configuration server, a dynamic case management (DCM) application development platform, a dynamic case management (DCM) model store, and a multitenant runtime platform. The DCM application development platform further comprises a business object builder, a presentation builder, a rule builder, a report builder, a dashboard builder, and a business process builder. The multitenant runtime platform further comprises a business data server, a rules processor, a content management server, a desktop renderer, a report server, a dashboard server, an audit server, an alert server, and a runtime security server. According to the embodiment, the runtime platform is adapted to operate in either of a shared multitenant application deployment model and a direct multitenant application deployment model.

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is a block diagram of components of the invention according to a preferred embodiment.

FIG. 5 is a block diagram illustrating a security model for handling multiple independent tenants, according to an embodiment of the invention.

FIG. 6 is a block diagram showing a method for providing direct multitenant applications, according to an embodiment of the invention.

FIG. 7 is a block diagram showing a method for providing shared multitenant applications, according to an embodiment of the invention.

FIG. 8 is a block diagram showing a multi-enterprise business process carried out according to an embodiment of the invention.

FIG. 9 is a block diagram showing integration with third-party elements according to an embodiment of the invention.

### DETAILED DESCRIPTION

The inventor has conceived, and reduced to practice, a system and various methods for hosted dynamic case management that address the shortcomings of the prior art that were discussed in the background section.

One or more different inventions may be described in the present application. Further, for one or more of the inventions described herein, numerous alternative embodiments may be described; it should be understood that these are presented for illustrative purposes only. The described embodiments are not intended to be limiting in any sense. One or more of the inventions may be widely applicable to numerous embodiments, as is readily apparent from the disclosure. In general, embodiments are described in sufficient detail to enable those skilled in the art to practice one or more of the inventions, and it is to be understood that other embodiments may be utilized and that structural, logical, software, electrical and other changes may be made without departing from the scope of the particular inventions. Accordingly, those skilled in the art will recognize that one or more of the inventions may be practiced with various modifications and alterations. Particular features of one or more of the inventions may be described with reference to one or more particular embodiments or figures that form a part of the present disclosure, and in which are shown, by way of illustration, specific embodiments of one or more of the inventions. It should be understood, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described, it will be readily apparent that more than one device or article may be used in place of a single device or article. Similarly, where more than one device or article is described, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be noted that particular embodiments include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be disclosed herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, and the like), a consumer electronic device, a music player, or any other suitable electronic device, router, switch, or the like, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or the like).

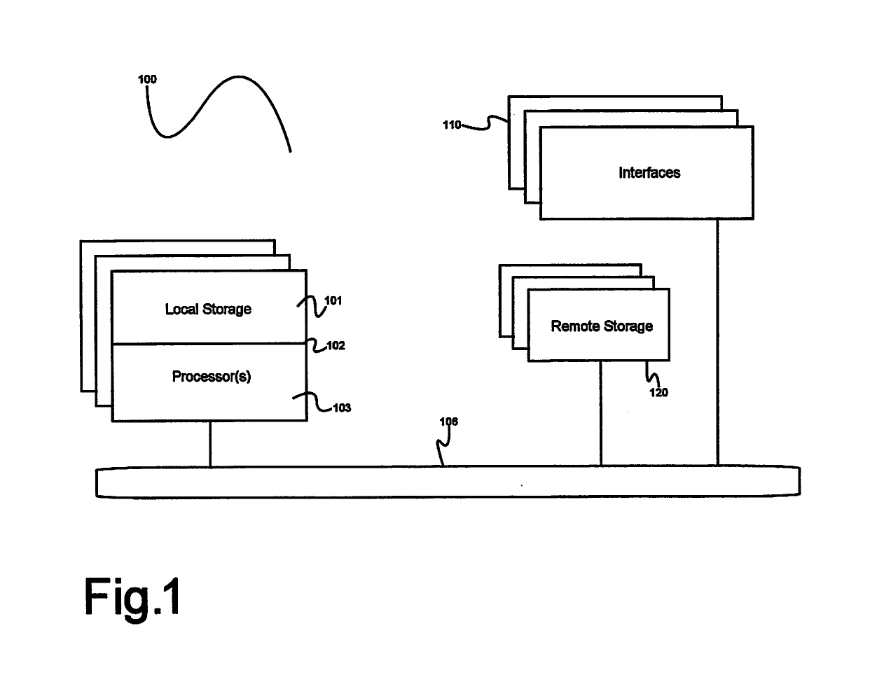

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, Firewire™, PCI, parallel, radio frequency (RF), Bluetooth™ near-field communications (e.g., using near-field magnetics), 802.11 (WiFi), frame relay, TCP/IP, ISDN, fast Ethernet interfaces, Gigabit Ethernet interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include ports appropriate for communication with appropriate media. In some cases, they may also include an independent processor and, in some in stances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory, solid state drives, memristor memory, random access memory (RAM), and the like. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

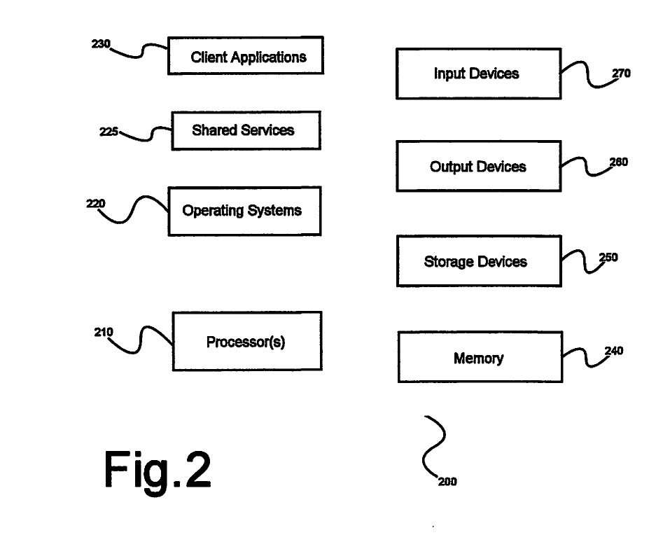

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's Windows™ operating system, Apple's Mac OS/X or iOS operating systems, some variety of the Linux operating system, Google's Android™ operating system, or the like. In many cases, one or more shared services 225 may be operable in system 200, and may be useful for providing common services to client applications 230. Services 225 may for example be Windows™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form. Examples of storage devices 250 include flash memory, magnetic hard drive, CD-ROM, and/or the like.

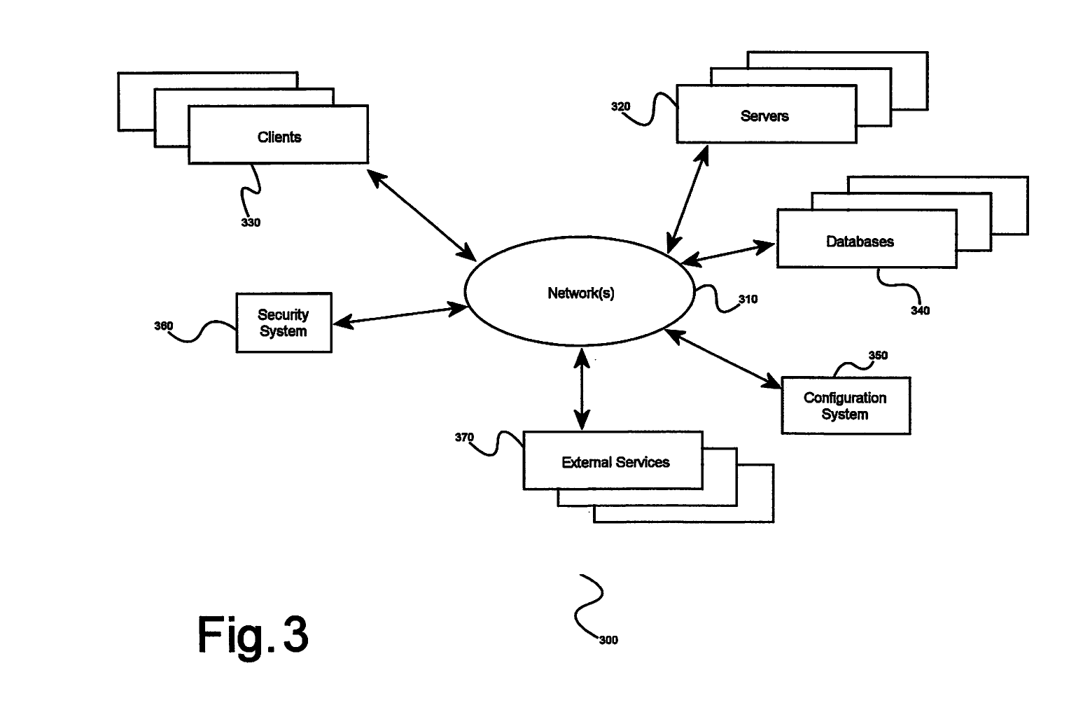

In some embodiments, systems of the present invention may be implemented on a distributed computing network, such as one having any number of clients and/or servers. Referring now to FIG. 3, there is shown a block diagram depicting an exemplary architecture for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network, a wireless network (such as WiFi, Wimax, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop, MapReduce, BigTable, and so forth). In some embodiments variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration 350 system or approach is specifically required by the description of any specific embodiment.

In various embodiments, functionality for implementing systems or methods of the present invention may be distributed among any number of client and/or server components. For example, various software modules may be implemented for performing various functions in connection with the present invention, and such modules can be variously implemented to run on server and/or client components.

### Conceptual Architecture

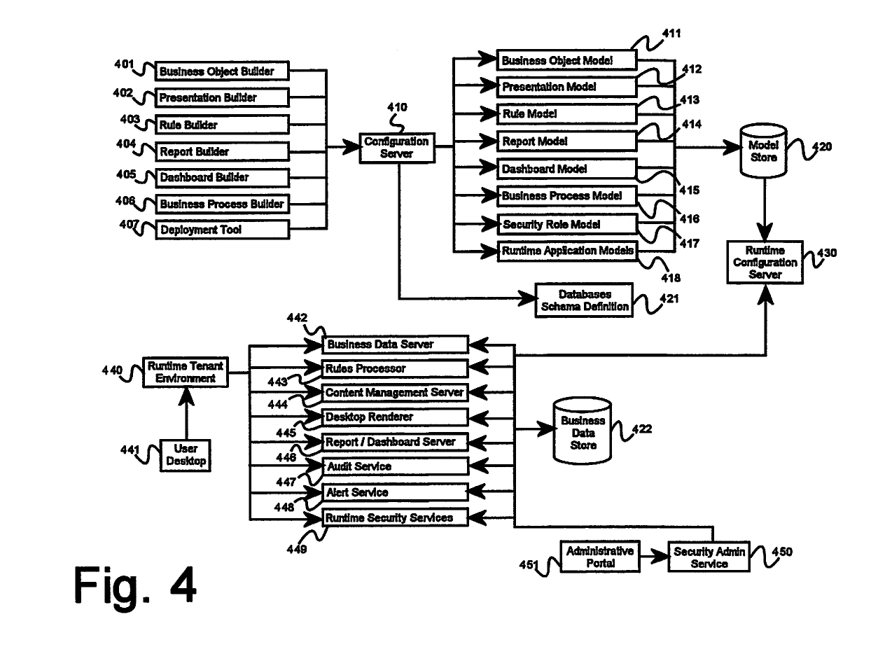

The inventors provide, in a preferred embodiment, and referring to FIG. 4, a system 400 that provides a dynamic case management (DCM) platform suitable for use in a “platform as a service” (PaaS) model. That is, systems 400 according to the embodiment can be deployed “in the cloud”, or in a public network, where it is accessible to a potentially large number of users from many different enterprises. While the inventor contemplates deployment of system 400 as a cloud-based platform-as-a-service, it should be appreciated that system 400 could as easily be deployed within an enterprise or even on a single computer, if desired, without departing from the scope of the invention. System 400 enables non-technical “business users”—the individuals who typically have responsibility for managing complex business processes such as insurance claims adjustment, crime investigations, and complex technical support operations—to configure flexible DCM applications, appropriate for use with complex business processes in the real world, using an ordinary web browser. Furthermore, system 400, by nature of its role as a cloud-based platform, is capable of managing complex business processes that span multiple enterprises, allowing data and events to flow across enterprise boundaries, subject to configurable security rules, in order to allow a plurality of enterprises to collaborate in delivering value to their joint customers (for example). Another example of the importance of being able to transcend enterprise boundaries is that a single enterprise, to deliver a complex service to its customers, is able to make use of specialized third-party service components that are located neither in their own enterprise nor in system 400, but in a facility of a specialized cloud-based service provider (who might, for instance, provide a service that checks potential transactions for indications of likely money-laundering).

System 400 is comprised of numerous functional components, which will each be described herein. It should be noted at the beginning, however, that the arrangement illustrated in FIG. 4 is exemplary in nature. As is well-known in the art, many alternative configurations are possible using modern computing technologies such as virtual machines (many logically independent elements operating on a single physical machine, and behaving as if they were separate computers) and clustering (a single logical component, such as a database management system, appearing to its clients as a single machine at a single network address, but in fact comprised of many closely-interoperating machines). For example, in general any combination of components illustrated in FIG. 4 could be arranged physically together, either on one physical server computer or on a single virtual server computer. Similarly, any single component can, when appropriate, be distributed across many physical machines. Additionally, there are several database-type components in system 400 (for example, business data store 422 and model store 420), and these may operate together within a single database management system or on separate database management systems without departing from the embodiment. Furthermore, some components such as configuration server 410 can be implemented as stored procedures within a database management system, or as standalone programs operating on a server, or even as scripted web pages operating on a conventional web server or web application server. What should be clear to one having ordinary skill in the art that the inventor's conception lies not in any particular programming language or architectural choices, but in the collection of functional elements, arranged together, that make it possible to deliver, as a service, a robust, scalable, secure, and easily configurable dynamic case management platform.

A central concept to the inventor's conception of a DCM PaaS system 400 is the notion of a DCM application. According to the invention, a DCM application (or application model) is a set of data that specifies all relevant rules and configuration data necessary to execute, at runtime, a specific dynamic case management process. DCM applications are developed, according to a preferred embodiment of the invention, using a dynamic case management (DCM) application development platform 408, which is accessed by users via ordinary web browsers. DCM application development platform 408 comprises a number of “builder” services, which are specialized web applications, typically delivered to a browser via a web server (not shown), each providing a development environment suitable for the building of particular parts of a DCM application. Of course, as described above, in many cases all of the builders provided by DCM application development environment 408 will be delivered from a single web server or web application server, and also in many cases the separate builders are each provided via a separate tab within a DCM application development web page provided by development environment 408. Generally, each builder provides a graphical, drag-and-drop style interface for building various models relevant to an intended DCM application. Users can generally start a new model from scratch, or they can load a predefined model, either of their own or another's design, for use a starting point when building or editing specific models.

An extension of the DCM application model is the concept of a “state-and-event” (SE) model in which a system 400 is considered to be in a “state”, or a current mode of operation, and events are transitions between states. Such an approach is highly flexible, allowing for a variety of events which may apply to a plurality of states and providing for persistence of a state across system 400, rather than taking a linear approach to event handling (for example, “Event A leads to Event B which triggers Event C”), increasing system robustness and reliability and providing for more flexible event handling since each event may not be required to take place before or after another event, each serving a discrete state-change transition rather than a step in a process. A variety of exemplary events are described in greater detail below, and it will be appreciated that a large variety of events may be implemented according to the invention.

Business object builder 401 provides, as described above, a graphical, web-based user interface that allows users to build or edit business object models 411. Each DCM application has as a base component one or more business object models 411. Business object models 411 are used to define types of business data a particular application will use, and it defines relationships between data elements. For example, in many DCM applications a main business object is “case”, which represents an instance of an end-to-end complex process. Examples of cases include murder investigations, insurance claims adjustments, unemployment insurance benefit applications, litigation matters, and so forth. Typically, dynamic case management systems are built around cases. Usually there are many other “business objects” in any given application, such as “client”, “provider”, “account”, and so forth. Each business object model 411 comprises many business objects, and each business object typically has one or more attributes. For example, business object “client” will typically contain attributes “Last Name’, “First Name”, “Street Address”, and so forth. Each business attribute in turn has a property called “data type”; for example, “Last Name” and “First Name” would be of type “Text”, whereas a business attribute “Date of Birth” might be assigned type “Date”. Typically, although not necessarily, business object attributes will also contain certain additional properties, such as “Length”; each business object attribute can be assigned any number of properties, and properties can optionally be provided with default values.

A second key part of business object model 411 is a set of relationships between business objects. Relationships can be viewed as “links” from one business object to another. For example, a “Client” business object may be linked, through a relationship, to a “Provider” who has been assigned to be their primary contact within an enterprise. Another important example is that “Case” objects typically are linked to a “Client”, and may also be linked to an assigned case manager who is a “Provider”. When relationships are properly established, it becomes possible to establish “views” across a given DCM application, such as “all cases assigned to members of provider group A, with the cases' current status”—this query or report would rely on links between “Cases” and “Providers”, between “Providers” and “Groups”, and it would also rely on each case's “Status” attribute. Relationships can be one-to-one, one-to-many, or many-to-many; it will be appreciated by one having ordinary skill in the art that there are many modeling tools and languages capable of fully representing sets of objects and relations, and that any of them can be used according to the invention. Typically, business object builder 401 is used to define objects, their relationships, and their attributes (or to edit those definitions), and a person whose role is to create a DCM application uses business object builder 401. Actual creation of instances of business objects is normally carried out at runtime by end users. However, it is contemplated by the inventor that users of business object builder 401 will sometimes create a small number of instances of business objects, and typically business object builder 401 will provide facilities for doing so.

Business object builder 401 allows users to interact with and modify business objects and their relationship in what may be called an “ad hoc workflow” (AHW). Such an example might be a bank manager needing to modify the criteria for an applicant's loan application, in which case they might access a web interface for business object builder 401 and directly manipulate existing information or create new information relative to this new AHW case. Such functionality allows greater flexibility, with users able to directly interact with their case management rather than relying on and waiting for a dedicated support or tech group to do so for them.

Configuration server 410 acts as an intermediary between DCM application development environment 408 and various models (such as business object model 411). Configuration server 410 in some embodiments enforces security rules, ensuring that no changes to models are made by unauthorized persons using DCM application development environment 408 (although normally this role is performed by DCM application environment 408 itself, checking security rights of each user as the user logs in to one or more builders). Additionally, configuration server 410 in some embodiments validates proposed changes or additions to models against one or more data integrity rules. In particular, configuration server 410 will generally enforce tenant data integrity rules. Since system 400 is intended to operate in a multitenant environment—that is, in an environment where many users from many different enterprises are using system 400 at any given time—it is important that, throughout system 100, rules regarding data integrity between tenants be enforced. For example, one tenant (enterprise) may create a particularly sophisticated client business model, and the tenant may desire that the model be kept invisible to other tenants. In other cases, either the operator of system 400, or a third party, or even another tenant, may build various models that are intended to be viewable (or even editable) by all or a subset of possible tenants.

While configuration server 410 acts as an intermediary between builders and models, it also provides access for builder components to predefined database schema definitions 421, which can then be used as a template from which to build new models. For example, in some embodiments database schema definitions 421 will contain predefined “Client”, “Provider”, and “Case” schemas that can be used as the basis for corresponding, tenant-specific models to facilitate quicker application development.

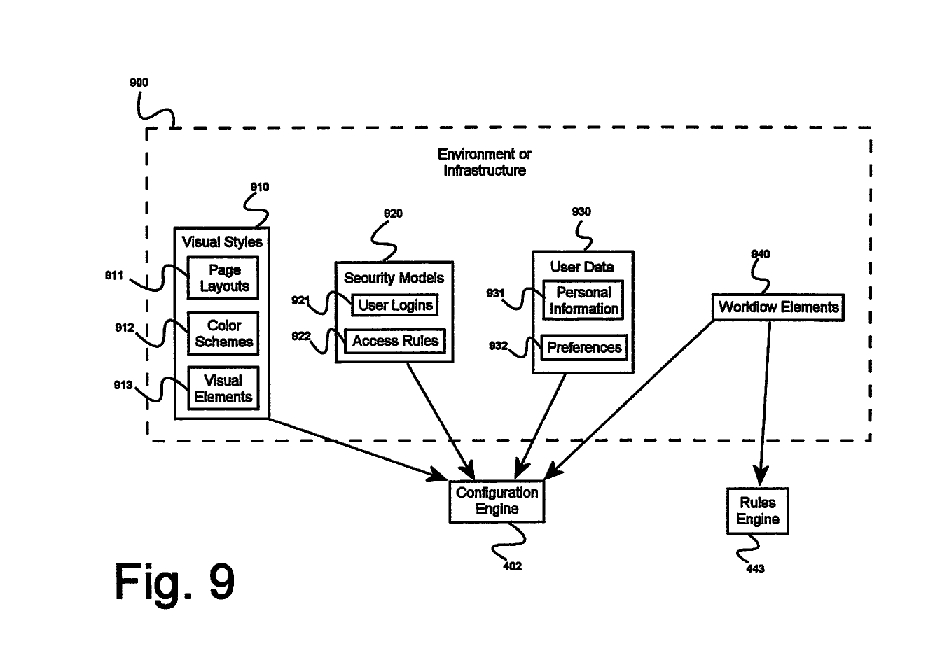

Configuration server 410 may also act as an intermediary between system 400 and additional third-party applications or environments, expanding flexibility and functionality by incorporating these elements into various aspects of system 400 as will be illustrated later, with reference to FIG. 9.

Business object model 411 and all other models defined within DCM application development environment 408 are stored in model store 420, which in a preferred embodiment is a relational database system (although, as mentioned above, it could be any type of data storage system known in the art, even a flat file).

Presentation builder 402 allows application designers to graphically (typically using drag-and-drop interface style) specify user interface elements that will be used, at runtime, by users of system 400. Such specified interface elements are assembled in presentation model 412 and stored in model store 420. For example, various screens for searching, editing, creating, and deleting various types of business objects can be specified. Such screens could be object-specific (for example, an “Add a Client” screen, which might not only allow a user to add a new client but also walk the user through a series of related steps required to be performed whenever a client is added), or general (for example, a general “Search” page which might include a pull-down list to specify the types of objects to be included in search results, and a series of fields for specifying search query parameters—such a search page could be used to search for objects of any type and is thus general). Presentation builder 402, in some embodiments, allows creation of hierarchical presentation models 412 comprising a plurality low-level presentation elements such as “Account—Short Form” and “Account—Long Form” and a plurality of higher-level elements such as predefined pages, which are assembled by placing low-level elements on them in specific layouts or locations.

Additionally, presentation builder 402 may incorporate elements of an existing environment such as fields, page layouts, color schemes, and other elements that may be imported as a part of integration via configuration server 401, as described previously. Incorporating such elements may allow a DCM system to present an appearance of “blending”, or extending an existing environment without disrupting a user's experience, and also may increase functionality and efficiency as well as decrease any familiarization time or learning curve by incorporating elements that are already familiar and commonly used. For example, if users within an enterprise are accustomed to interacting with a specific customer relationship management (CRM) system, and have become adept at using a variety of user interface conventions and techniques “native” to that CRM system, then according to the embodiment the various novel features of a dynamic case management system 400 according to the invention may be provided to such users within that CRM system and its user interface paradigm, thus avoiding the common problem of having to force users to learn a new set of application behaviors. It should be understood that such elements being incorporated are exemplary, and there are a multitude of elements which may be useful to incorporate according to the specific implementation of a DCM system 400 as well as a specific environment or application being integrated with.

Rule builder 403 provides a web-based user interface to allow a DCM application designer to specify or edit business rules that will be used to drive application behavior at runtime, further enabling ad hoc workflow functionality as described previously. Business rules for a particular DCM application created or edited in rule builder 403 are assembled in rule model 413 and stored in model store 420. Rule builder 403 is, in some embodiments, a graphical, drag-and-drop style web page, but rule builder 403 may also be of a more text-oriented style, for instance with a table for rule elements that can be populated by a DCM application designer, possibly using pull-down lists or other well-known user interface widgets or elements to facilitate easy rules configuration. Rules are created using other elements previously created within DCM application development environment 408. For example, a rule might be created stating: “If CLIENT has more than two ACCOUNTS, and the sum of all BALANCES within all of CLIENT'S ACCOUNTS is more than $150,000, then set CLIENT′S SEGMENT to 5”. The capitalized words are names of business objects or their attributes, all of which would have been previously defined within business object builder 102, and thus available within rule builder 403.

According to a state-and-event (SE) model as described previously, rule model 413 may also be used to implement a variety of workflow events which may be triggered by workflow rules, and which may transition system 400 to a new state. Exemplary events may include, but are not limited to:
a. Workflow Create Workitem Event—A new workflow or business object is created.
b. Workflow Initialize Event—New workflow is initialized and processing begins.
c. Workflow Finalize Event—Workflow is completed.
d. Workflow Load Workitem Event—Existing business object is added to workflow.
e. Workflow Update Workitem Event—Business object is modified.
f. Workflow Validate Workitem Event—Business object is checked against known information for validity and relevance to workflow.
g. Workflow Split Workitem Event—Workflow is split or “branched”, creating multiple parallel routes within a workflow.
h. Workflow Join Workitem Event—Previously created parallel routes within a workflow are merged.
i. Activity Initialize Event—Workflow instance arrives to activity initializing activity related processing.
j. Activity Finalize Event—Workflow instance leaves activity.
k. Activity Execute Event—Activity related business process execution begins.
l. Activity Routing Event—Transition between activities begins.
m. Activity Validate Send Event—Business process or object is validated for transition and resulting validation is sent to workflow.
n. Transition Send Event—Workflow instance is routed via transition.
o. Transition Validate Send Event—Workflow state transition is validated.

As described, some events may interact with configuration server 410, rules processor 443, or other elements of system 400 as needed. Such events are exemplary, and it will be appreciated that a multitude of events and states are possible according to the invention, and as needed by any particular implementation of the invention.

Report builder 404 provides a web-based user interface to allow a DCM application designer to specify or edit reports that will be provided to end users at runtime. Reports for a particular DCM application created or edited in report builder 404 are assembled in report model 414 and stored in model store 420. Report builder 404 is, in some embodiments, a graphical, drag-and-drop style page, but report builder 404 may also be of a more text-oriented style, for instance using a tabular format (which is commonly how reports are delivered and consumed). Reports stored in report model 414 may be stored in a number of ways known in the art, including extensible markup language (XML), including possibly of a specialized variant designed for reporting, such as Report Markup Language (RML). However, it will be clear to one having ordinary skill in the art that there are a large number of well-established ways to store report-related data, any of which can be used according to the invention.

Dashboard builder 405 and dashboard model 415 are in many ways analogous to report builder 404 and report model 414, and in fact the two could be combined. Dashboards tend to be more real-time and graphical in their presentation of data, but basically serve the same function as reports.

Business process builder 405 provides a graphical, web-based user interface that allows drag-and-drop composition of complex business processes, further enabling ad hoc workflow creation as described previously. In marked contrast with typical business process management platforms, where process definition is typically done in either code or in a code-like markup language, business process builder 405 allows a non-technical user to compose or assemble complex processes without writing (or even seeing) any code. Processes are built up using elements previously defined with DCM application development environment 408. Business rules defined in rule builder 403 can be used to filter a set of objects or to determine which execution branch to take. Reports and dashboards defined in report builder 404 and dashboard builder 105 can be updated or sent to specified individuals from within a business process. Business processes designed within business process builder 406 are assembled in business process model 417 and stored in model store 420. In many cases, according to preferred embodiments of the invention, business processes are designed hierarchically. For example, fairly focused and commonly-used business processes such as “validate risk factors” or “update customer address” may be defined once and then included as sub-processes within larger, more complex business processes, such as “originate home mortgage loan”.

An overall DCM application, generally corresponding to some highest-level business process, can be assembled using deployment tool 407. Assembling a DCM application essentially means specifying processes to be carried out under the application, reports and dashboards to be provided to managers responsible for the process (or for the line of business that carries out the process, or for a geographic territory, and so forth), and presentation elements to be provided to end users who actually carry out the process. Also, deployment tool 107 allows a designer to specify that an application can be added to a public application library, and optionally to specify rules about who may access the application (and for what price), either to run it as is or to use it as a template from which to design their own derivative application. When an application is assembled, it is placed in runtime application models 418 and stored in model store 420.

As can be seen from the descriptions above of the various builders and models associated with system 400, DCM applications are comprised of a plurality of interrelated models stored in model store 420. Runtime configuration server 430 is responsible for providing current models to various components of DCM runtime engine 439, and for notifying runtime components when models underlying their operation are changed. This is important as a designer may elect to modify an existing model that has already been deployed into production (that is, a model that is actively running in DCM runtime engine 439), with potentially hazardous results. When the designer in such a situation deploys the modified model using deployment tool 407, and the associated runtime application model 418 is updated, then runtime configuration server 430 is responsible for properly notifying DCM runtime engine 439 of the change. Changes to existing, and possibly running, applications can be made in a variety of ways, each with advantages and disadvantages. Consider what happens when a business process is modified, for instance by deleting a step. If the change is implemented immediately, then clearly a designer's intent is given immediate effect, which can be seen as a definite advantage (particularly if the designer is fixing a problem with an existing business process). But if there are many instances of the effected business process currently running when the change is made by the designer, some of them may have already taken the now-deleted step, others may be just about to take the now-deleted step, and still others may be much earlier in the process. In this case, if the change is effected immediately, then an instance of the process which just passed the now-deleted step would be unaffected, but an instance just approaching the now-deleted step would not take that step, thus differentiating it from the first instance (that had already passed the point). Now the runtime engine is handling multiple instances of the same business process, which are distinct in that some had the now-deleted step performed, some didn't, and some have yet to reach the point in question. If one considers reports generated based on operation of many instances of the business process, it will be very difficult to know how to handle this situation from a reporting (or dashboard) point of view. One could, of course, track performance on a per-application-version basis, which would clearly separate the original business process from the business process with a deleted step (which would have a different version number, managed by configuration server 410 or runtime configuration server 430). Or, reports could be generated based on a per-application (business process) basis, and the loss of certainty (which would be minor) could simply be tolerated. Another approach would be to only put the change into effect in DCM runtime engine 439 when there are no instances of the affected business process being executed by DCM runtime engine 439. This has the advantage that no confusion will exist from having multiple versions executing simultaneously, but it has the possibly important side effect that the time when a given change will actually be implemented in DCM runtime engine 439 cannot be known in advance, since it will not be clear when the first time will occur when there are no instances of the affected business process running (indeed, it could be days before that happens). Yet another approach would be to make a change at a predetermined time, generally corresponding to a boundary between reporting time intervals (for instance, at the end of a day or an hour). Yet another approach would be to only implement the changed version of the application (business process) for instances of the business process that start after the change has been loaded. That is, all instances that were running when the change was loaded will ignore the change, while all newly-instantiated instances will use the new version. Clearly there are many possibilities, any of which may be used according to the invention.

Business data store 422 is a data repository for “real world” data. Whereas model store 420 stores abstract models of, for example, a generic client, business data store 422 stores data about actual clients. The structure of data stored in business data store 422 corresponds to the applicable models stored in model store 420, but the content will be specific to each individual client (or other business object). Another way to view this relationship is to consider that model store 420 contains empty, abstract descriptions of particular classes of objects (“clients”, “cases”, etc.), with no data (except possibly default values) stored, and with only one record stored per type of object. Thus model store 420 stores a single model of “client” (although it should be noted that there may be many distinct abstract models of “client”, each one representing a particular model version for a particular tenant), to which all clients actually conform. Business data store 422, on the other hand, contains populated instances of objects, each corresponding in structure to the corresponding abstract model but populated with real data. Moreover, business data store 422 will store data corresponding to many clients (for example), each containing data pertaining to that specific client, Model store 420 is populated by DCM application development environment 108, whereas business data store 422 is populated by DCM runtime engine 439.

During runtime operation, users interact with system 400 via a user desktop 441, which could be a web page displayed within a browser or a dedicated application. Moreover, user desktop 441 could be a mobile application running on a mobile phone or a tablet computing device. It will be appreciated by one having ordinary skill in the art that there are many ways for a user to interact with a platform, and any of these may be used to implement user desktop 441. User desktop 441 interacts with system 400 through a runtime tenant environment 440, which manages tenant-specific data security rules and ensures that any given tenant does not bring down the entire system 400, for example by being a target of a denial-of-service attack. In some embodiments, runtime tenant environment 440 carries out a caching function, caching data (that is, business objects) that are frequently used so that repeated queries to business data server 442 are not required. In such embodiments, any of various means known in the art can be used to ensure that cached data is kept up-to-date, for instance, by having business data server 442 send a notification to runtime tenant environment 440 when a business object has been changed, particularly if runtime tenant environment 440 has previously notified business data server 442 that it is caching the business object in question.

While users interact with DCM platform 400 via user interface 441, which in turn passes all requests and receives all responses from runtime tenant environment 440, execution of actual DCM applications in runtime takes place in DCM runtime engine 439, which is a collection of web-based servers (or services; the two terms can be considered synonymous), each carrying out a distinct subset of an application's functionality, and each based on corresponding models stored in model store 420. Business data server 442, which is driven by business data model 421, provides access to business objects (data) in runtime. As described above, business data representing actual business objects is stored in business data store 422, to which business data server 442 has access. Rules processor 443 is a rules engine analogous to those well-known in the art, and has the function of processing business rules defined in rule model 413, applying actual data in the execution of rules. For instance, the rule described above regarding client segmentation was defined in rules builder 403 without reference to actual client data, but when the rule is executed by rules processor 443 the rule is evaluated with actual data (in this case, using actual values for CLIENT, ACCOUNTS, account BALANCES, and populating the field SEGMENT of the CLIENT business object in accordance with the rule, based on the actual values).

Content management server 444 is a service that provides well-understood enterprise content management functionality, and which thereby ensures accuracy and currency of any content provided to a user in conjunction with a DCM application. For example, if a user is a loan officer considering a complex loan application, the user might have need, during the course of managing the case (the complex loan application), to conduct a review of certain specific regulations pertaining to the type of loan requested. The required content would be served up by content management server 444, and the user would not have to manually check to make sure she had the most current information. Desktop renderer 445 uses presentation models 412 to populate user interface 441 with user interface elements as designed in presentation builder 402. Similarly, report/dashboard server 446 uses report model 414 and dashboard model 415 to populate and render reports and dashboards via user interface 441.

Business process server 455 executes a business process created by a user through a business process builder 405, optionally in conjunction with a rules processor 443. A rules processor 443 may be utilized to apply known rules defined in a rule model 413 or new rules created within a business process builder 405 for use in a specific business process, and may allow a business process server 455 to facilitate internal execution, routing, and transitioning of a business process.

Audit service 447 tracks all usage of DCM runtime engine 439, and stores all usage-related data in business data store 422. Audit service 447 is configured using runtime configuration server 430, for example by specifying what types of actions or events are to be captured and retained for audit purposes, and by specifying what types of audit reports will be prepared (and how often they will be prepared).

Alert service 448 has the role of providing alerts to users (via user interface 441, or via notification via email, short message service, instant messaging, or any other means known in the art) when configurable alert conditions are met. For example, an alert may be triggered when an elapsed time for carrying out a certain step in a certain business process has been missed. Such an alert would be configured in two parts. First, in the relevant business application's rule model 413, a rule would be configured that states that, if a certain action isn't taken within a specified time, an alert should be generated. Second, actual parameters used to send the requested alert are determined by alert service 447. For example, the identities of personnel to whom the alert is to be sent would be determined by executing a query to business data service 442 (because roles and responsibilities of individuals associated with tenants are provided as attributes of the respective business objects). In some cases, alerts are sent to staff of DCM platform 400 rather than personnel of any specific tenant; in such cases, configuration information required may be obtained either from business data server 442 or from runtime configuration server 430.

Runtime security service 449 enforces security roles of all individuals interacting with DCM runtime engine 439, particularly by preventing unauthorized actions from taking place. In some embodiments, when an unauthorized action is attempted, an alert request may be generated and sent to alert service 448 to notify appropriate people. Security rules and parameters are configured by DCM platform 400 personnel using administration portal 451, which provides configuration data to security admin service 450, which maintains all security administration data and rules. In some embodiments, comprehensive audit data is passed by audit service 447 to security admin service 450 so that DCM platform 400 staff is able to review any aspect of security.

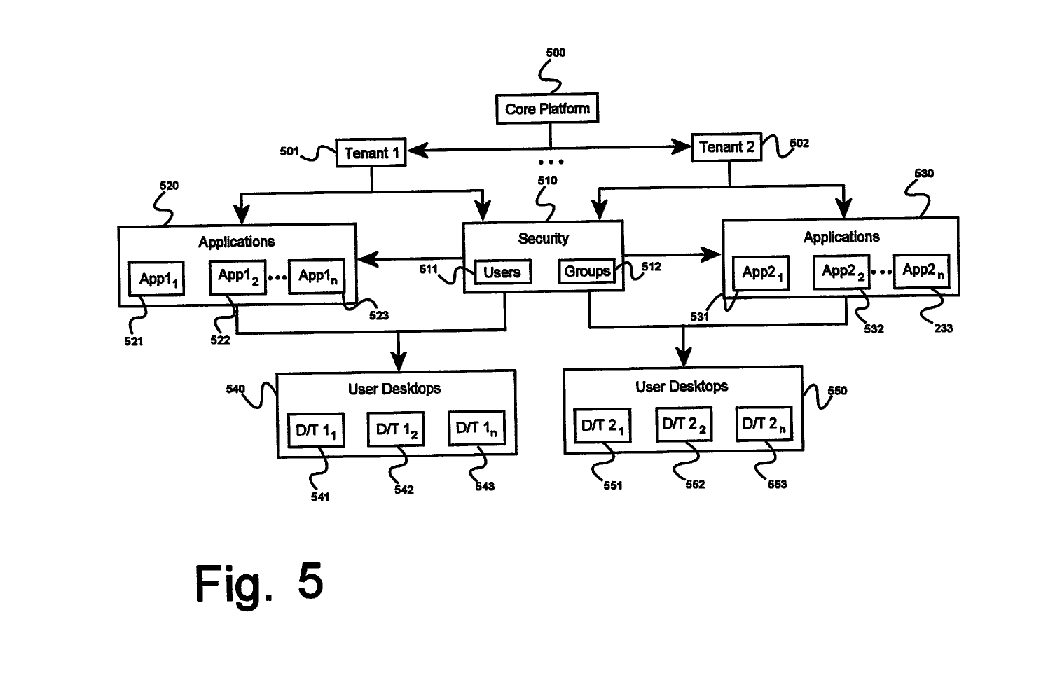

FIG. 5 is a block diagram illustrating a security model for handling multiple independent tenants, according to an embodiment of the invention. Core platform 500 comprises services that are applicable to, and used by, many or all DCM applications operating on DCM platform 400, for example audit service 448, alert service 449, and various databases such as model store 420 and business data store 422. Access to core platform 500 elements is generally limited to DCM platform 500 staff, in an analogous way to the division of access rights in Unix™-like systems between those having root access to a machine, and those having access as users with specified rights within “user space”. According to preferred embodiments of the invention, tenants 501, 502 have certain security rights that apply to all users and applications operating within tenants' 501, 502 subdomain (that portion of users, data, and active applications associated by platform 500 with tenant 1 501 or tenant 2 502, for example). Each tenant 501, 502 has a plurality of DCM applications 520, 530, configured as described above with reference to FIG. 4. For example, tenant 1 501 has provisioned and operates applications 11 521, 12 522, and In 523, where n is a number representing a total number of applications configured on behalf of tenant 1 501. Similarly, tenant 2 502 has provisioned and operates applications 21 531, 22 532, and 2n 533, with n here representing a number of applications configured on behalf of tenant 2 502. Note that while two tenants are needed to illustrate certain aspects of a security model according to the embodiment, in most cases there will be many more than two tenants making use of DCM platform 400 at any given time.

While, according to the embodiment, each tenant 501, 502 has complete control of, and responsibility for, applications configured on their behalf, a common security model 510 applies to all tenants subscribing to services provided by DCM platform 400. Security model 510, again in a way that is analogous to the well-known Unix™-style security model, maintains a single database of users 511, and a second database of groups 512, to which users 511 may belong. It is important to have a common security model 510, since if each tenant were to independently manage security, problems such as poor security administration or duplicate user names across DCM platform 400 could easily occur, rendering DCM platform 400 potentially unsafe for all tenants, rather than just an offending tenant.

Tenant 501 enables interactions between users and DCM platform 400 by providing a plurality of user desktops 540, including for example desktop 11 541, desktop 12 542, and desktop 1n 543, where n represents a number of user desktops enabled by tenant 501. Similarly tenant 2 502 enables interactions between users and DCM platform 400 by providing a plurality of user desktops 550, including for example desktop 21 551, desktop 22 552, and desktop 2n 553, where n represents a number of user desktops enabled by tenant 502.

As can be seen in FIG. 5, each user desktop interacts directly with one or more applications configured on behalf of its associated tenant, while simultaneously having security rules enforced by common security engine 510. For example, when a user using desktop 11 541 begins a new session at the beginning of a shift, she is required (by security engine 510) to successfully login. Login credentials are checked by security engine 510 to prevent unauthorized access to tenant applications or to core platform 500. Similarly security engine 510 enforces access rules intended to prevent, for example, denial of service attacks (potentially by looking for multiple logins from a small range of IP addresses, using user identities from multiple tenants 501, 502). Once a user has been successfully validated and logged in, a token or datagram is sent, according to some embodiments, from security engine 510 to the appropriate tenant 501, 502 (the tenant to whom the user in question belongs), advising tenant 501, 502 of the identity and validated status of the user. Tenant 501, 502 then provides access to applications 520, 530 as appropriate for the individual user's allowed roles and access rights (which can be obtained from security engine 510).

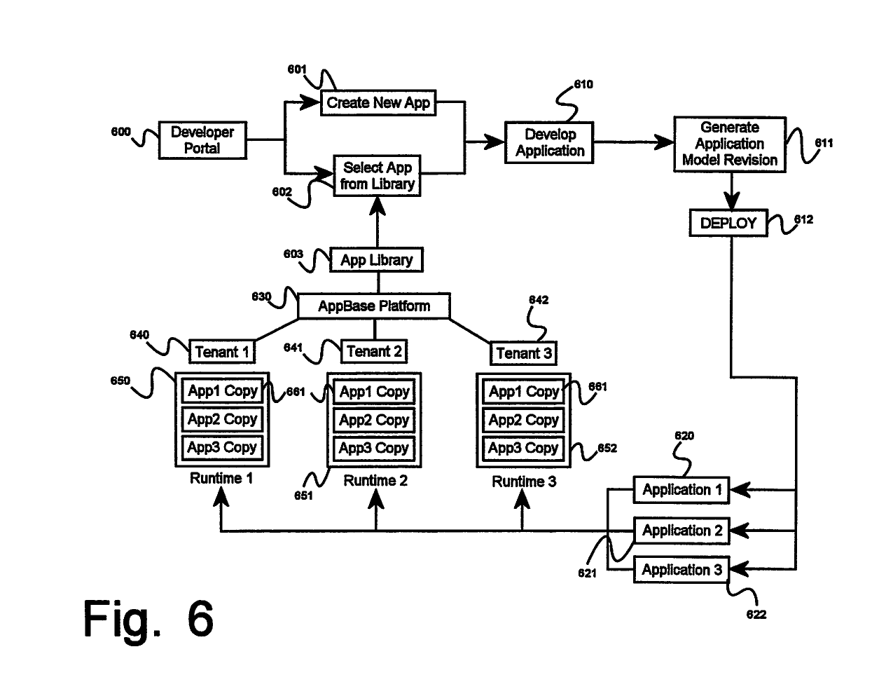

FIG. 6 is a block diagram showing a method for providing direct multitenant applications, according to an embodiment of the invention. According to the embodiment, a user interacts with developer portal 600 to design, configure, and deploy DCM applications. A user may elect to create a new application in step 601, or may alternatively elect to select an application, in step 602, from application library 603, for use as is, or as a template for further configuration. If a user elects to create an application in step 601, the user is typically prompted (within developer portal 600) to enter a name for the application, and the user may optionally have specific access restrictions to the application. If the user elects to start with a prebuilt application from application library 603, the user may elect to use the application as is, or she may elect to use the selected application as a starting point to facilitate quicker application design and configuration. Once an application has been selected or initiated, it is designed in detail by the application developer (or designer; the two terms may be used interchangeably herein) in step 610. This step may take place over numerous sessions wherein the developer or designer interacts with developer portal 600, with designers having the ability to save work between sessions. Designers access, via developer portal 600, all features provided by DCM application development environment 408, in particular the various model builders such as business object builder 401, presentation builder 402, and the like. In some embodiments, applications being actively designed are saved as sets of working data by system 400, so that until a designer has finished work (possibly over many sessions), others will not have access to the application under design. In other embodiments, collaborative application design and development is enabled (that is, step 610 may be carried out for a particular application by a plurality of users (developers/designers), potentially across a plurality of sessions separated in time, each user working with intermediate work product designed earlier by the same or other users.

When a developer, or a set of developers, is satisfied with a developed application, the developer generates an application model revision in step 611. In some embodiments, applications are assigned a new revision in step 611 as soon as any changes from a previous version are saved, even if the application is not yet considered complete by the designer. It will be appreciated by one having ordinary skill in the art that many sophisticated tools have been made available in the art for the management of collaborative development and software version control, any of which may advantageously be used in conjunction with embodiments of the invention. Once a new version of an application has been tested, it is deployed in step 612. Deployment means the application is configured for use within DCM runtime engine 439.

According to a preferred embodiment of the invention, applications 620-622 are made available to a plurality of tenants (although some applications may be designated as tenant-specific and limited to use by the relevant tenant). It is advantageous, according to the invention, to make applications available for direct copying and use by multiple tenants, in order to facilitate various models of collaboration and sharing with regard to applications. For example, in some embodiments third party specialist application developers (or even staff of DCM platform 400) may elect to build certain preconfigured applications in anticipation of selling, renting, or sharing them to (or with) one or more tenants 640-642. In other embodiments, an application built by one tenant (for example, tenant 1 640) might be made available to others in anticipation that those others might similarly share their home-grown applications. In yet other embodiments, some applications may be developed by a plurality of tenants 640-642 working together, in order that the applications may be used by them collectively to manage complex business processes that are carried out by more than one enterprise. In any case, applications 1-3 620-622 may be deployed directly by tenants 1-3 640-642 by loading a copy of an application 620-622 into runtime tenant environment 650-652 (corresponding to runtime tenant environment 440 in FIG. 4). This, for example, if all three applications 620-622 were to be used by all three tenants 640-642 as shown in FIG. 6, then each runtime tenant environment 650-652 would have a copy 661 of each application. It should be noted that applications 620-622 are made available for loading into tenant runtime environments 650-652 via business data store 422. In some cases, it will be desirable to make successful applications available for use in building improved versions. In this situation, applications 620-622 would be loaded into a DCM application library 603, which generally (but not necessarily) would be stored in model store 420.

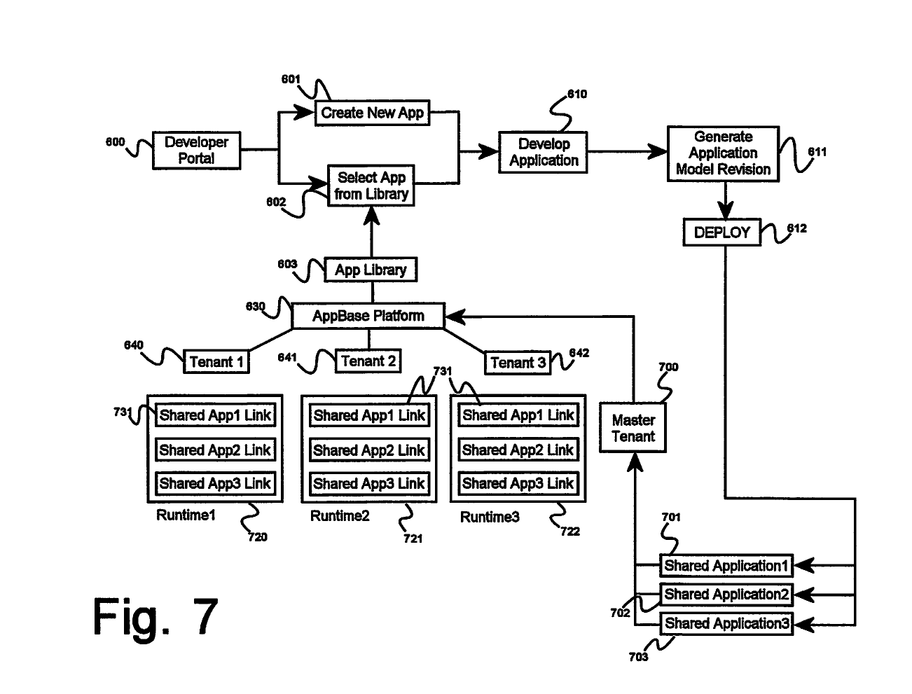

FIG. 7 is a block diagram showing a method for providing shared multitenant applications, according to an embodiment of the invention. The initial steps of FIG. 7 correspond to the same steps in FIG. 6, but FIG. 7 illustrates a variant embodiment that allows for a single application to be shared among multiple tenants (sharing as in all tenants access a same physical location to retrieve the application, and also sharing where a change made by one tenant would be seen by all other tenants using the same version, as opposed to the direct application copying model shown in FIG. 6). To accomplish this, a master tenant 700 is maintained, generally by the operator of DCM platform 400, and shared applications 701-703 are loaded therein, rather than in individual tenant runtime environments 720-722. Then, each tenant configures its runtime tenant environment 720-722 with a link 731 to one or more of shared applications 701-703. It will be appreciated that, for applications having very broad applicability (such as change of address applications), it may be desirable from a configuration management point of view to maintain a single, easy-to-maintain, copy of each shared application 701-703 rather than having each tenant maintain its own independent copy as in FIG. 6.

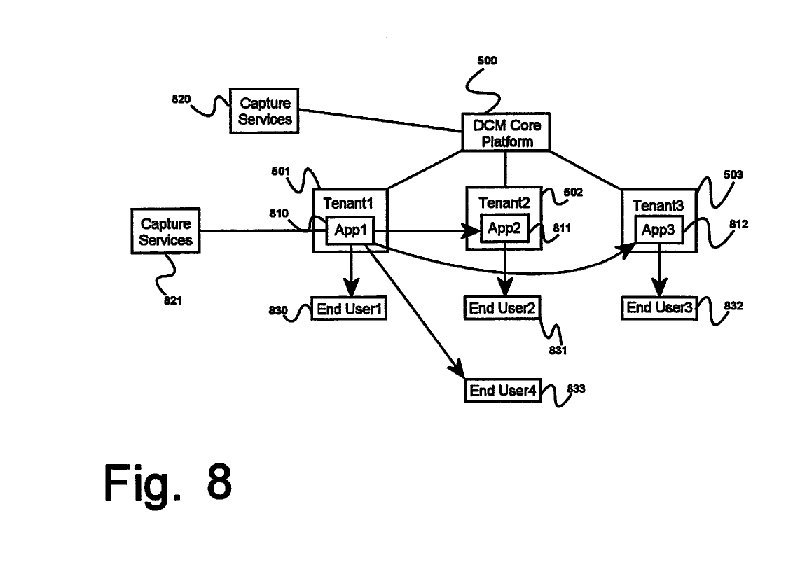

Because of the multitenant, cloud-based architecture of DCM platform 400, many variations are contemplated by the inventor, and in fact DCM platform 400 is in general considered capable of delivering novel DCM solutions that were heretofore impossible or extremely difficult (and expensive) to carry out. For example, and referring to FIG. 8, it is possible according to an embodiment of the invention to carry out (as suggested above) a multi-enterprise business process—that is, a business process carried out using people and resources of a plurality of distinct business entities (enterprises). In one embodiment, tenant 1 501 implements a DCM application 810 within its runtime DCM environment. Like most DCM applications, application 810 is carried out in distinct phases, starting with opening a new case, then processing the case, and finally closing the case. In most applications, during opening and processing phases, it is necessary to “capture” documents or other artifacts using capture services 820, 821. Capture services include fax servers such as high-speed automatic fax processing devices, scanners including high-speed automatic scanners, optical character recognition software modules, email processors, and online forms, and may be deployed by a tenant in its own facilities (capture services 821) or as an additional service provided by DCM core platform 500 (capture services 820). Similarly, archive services may be optionally provided, such as long-term storage on tape, disk, or storage arrays using any storage technology known in the art.

In the exemplary embodiment illustrated in FIG. 8, user 830 interacts with application 810 (often as a case manager, although user 830 could be involved in any number of roles, and more than one user from tenant 501 can certainly be used). In some cases, as shown in FIG. 8, applications make use of other applications to provide one or more functional services, or to carry out a portion of an overall case workflow; that is, applications may be designed and executed in a hierarchical or ad hoc, networked fashion. In some situations one application is a governing application for a given case or class of cases, while in other situations the role of managing a case may actually move automatically from one application to a peer application. In FIG. 5, application 810 is designed to make use of services provided by application 2 811 operating within and on behalf of tenant 2 502, with involvement of user 2 831, who is part of tenant 2 502's business organization. Similarly, application 3 812 operated by tenant 3 503 and using user 3 832 (part of tenant 3 503's organization), is used in conjunction with application 1 810. Either of application 2 811 and application 3 812 may be used as a dependent, or subordinate, application from the perspective of application 1 810's business process logic, or either of application 2 811 or application 3 812 may be used as peer applications that assume control of a case for at least a portion of the overall business process used to manage the case. Finally, in some cases end user 4 833, who is not associated with any tenant, may participate, whether as a subcontractor or as an independent provider of a specialized on-demand service, under control of application 1 810 (or indeed of any of the applications 810-812).

It should be noted that many possible business arrangements between tenants and service providers (such as user 4 833) are contemplated by the inventor according to the invention. For instance, tenant 2 502 may be contractually obligated to perform certain functions while appearing to a consumer as if it were a part of tenant 1 501's enterprise. On other cases, some consumer needs may be quite complex and ad hoc, and require unrelated services to be carried out by one or more of tenants 1-3 501-503, although often one of the tenants acts as “prime contractor” and is perceived by the requesting consumer as the enterprise from whom the services are being received. In some embodiments, one or more of tenants 2,3 502, 503 and the like may act as outsourcers, taking on responsibility for fulfilling demand for one or more sub-processes (such as address changes), and doing so for a range of enterprises (tenant 1 501 in the example of FIG. 8).

In some cases, such as when specialized services are provided by end user 4 833, DCM core platform 500 may act as a broker and reputation manager and maintain a register of qualified specialized service providers, including their rates and their reputations, so that tenant 1 501, for example, could simply request from DCM core platform 500, “please get me a qualified accountant with at least a 98% feedback score to review this document”, and user 4 833 would be incorporated as a part of the overall business process managed by application 1 810 directly. In such cases, payment may be made from tenant 1 501 to DCM core platform 500 for the accounting services, and DCM core platform 500 would pay end user 4 833 his appropriate fee. It will be appreciated by one having ordinary skill in the art that many variations are possible, essentially including and kind of composition of direct and indirect services provided by one or more tenants in order to meet a customer's need. Thus, as envisioned by the inventor, a DCM platform 400 would be able to provide an application library containing a wide range of prebuilt templates and ready-to-use applications, and to act as a broker between enterprises who need to efficiently carry out complex business processes and third party service providers who may desire to provide specialized services on an ad hoc basis for a wide range of enterprises with a minimum of technology overhead.

FIG. 9 is a block diagram illustrating integration of a DCM system 400 with various third-party elements. As illustrated, configuration server 402 may serve as an intermediary to facilitate the integration of a DCM system 400 with a corporate environment or infrastructure 900, which may comprise a plurality of third-party elements, for example visual styles 910, security models 920, user data 930, or existing workflow elements 940 such as rules or event types. As illustrated, each of these elements may integrate directly with configuration server 402, or they may as appropriate integrate with alternate elements of a DCM system 400 such as existing workflow elements 940 integrating directly with a rules engine 443. As further illustrated, each integrated element may itself incorporate further elements which may be made available to a DCM system 400, such as visual styles 910 comprising page layouts 911, color schemes 912, or visual elements 913 such as button or scrollbar design. Security models 920 may comprise user login information 921 such as username/password combinations or security keys or certificates, access rules 922 such as might control which users may perform actions, as well as what sort of actions and where they may be performed. User data 930 may comprise personal information 931 such as a user's name, address, or contact information, as well as preferences 932 which may be utilized by a DCM system 400 when determining behavior for a user. It will be appreciated by one having ordinary skill in the art, that such elements are exemplary in nature and a wide variety of elements, behaviors, and information may be integrated according to the invention, and it will be further appreciated that not all elements may be relevant to any particular implementation of a DCM system 400, and that such environments or infrastructures as might be integrated may vary widely.

All of the embodiments outlined in this disclosure are exemplary in nature and should not be construed as limitations of the invention except as claimed below.

What is claimed is:

1. A dynamic case management system, comprising:
a configuration server;
a dynamic case management application development platform, comprising:
a business object builder;
a rule builder;
a dashboard builder; and
a business process builder;
a dynamic case management model store; and
a multitenant runtime platform, comprising:
a business data server;
a rules processor;
a business process server;
an audit server;
an alert server;
a runtime security server;
wherein the runtime platform is adapted to operate in either of a shared multitenant application deployment model and a direct multitenant application deployment model.

2. A dynamic case management system, comprising:
a dynamic case management application development platform, the development platform comprising one or more of a business object builder, a rules builder, a report builder, and a business process builder; and
a multitenant runtime platform, the runtime platform comprising one or more of a business data server, a rules processor, a business process server, an audit server, and a runtime security server;
wherein the runtime platform is adapted to operate in either of a shared multitenant application deployment model and a direct multitenant application deployment model.

3. The system of claim 1, further comprising a library of dynamic case management applications, the library enabling users of the development platform to retrieve a pre-build dynamic case management application from the library for use or customization by the user.

4. The system of claim 3, wherein the library makes available to one or more users a plurality of dynamic case management applications from third-party application developers.

5. The system of claim 1, wherein the development platform enables development of, and the runtime platform enables execution of, chained or multi-tiered applications.

6. The system of claim 5, wherein the chained or multi-tiered applications comprise applications from at least two distinct corporate entities.

7. The system of claim 6, wherein one of the corporate entities is the operator of the runtime platform.

8. The system of claim 1, wherein the runtime platform enforces a shared, role-based security model across multiple tenants.

9. The system of claim 2, further comprising a library of dynamic case management applications, the library enabling users of the development platform to retrieve a pre-build dynamic case management application from the library for use or customization by the user.

10. The system of claim 9, wherein the library makes available to one or more users a plurality of dynamic case management applications from third-party application developers.

11. The system of claim 1, wherein the development platform enables integration of a dynamic case management application with a primary enterprise application; and
further wherein end users of the dynamic case management application interact with the dynamic case management application using user interface standards and user interaction paradigms determined by the primary enterprise application.

12. The system of claim 1, wherein the runtime platform enables user creation and modification of ad hoc workflows.

13. The system of claim 11, wherein the configuration manager supports integration of elements of a third-party environment or infrastructure.

14. The system of claim 2, wherein the runtime platform enforces a shared, role-based security model across multiple tenants.

15. A method for developing and deploying dynamic case management applications in a cloud-based service, the method comprising the steps of:
(a) creating a new dynamic case management application within a developer portal, or optionally loading a pre-built application from a dynamic case management application library accessed via the developer portal;
(b) further developing the dynamic case management application within the developer portal using at least one of a business object builder, a presentation builder, a rules builder, a report builder, a dashboard builder, and a business process builder;
(c) generating a unique dynamic case management application revision for the dynamic case management application developed in step (b); and
(d) deploying the application into a dynamic case management runtime platform, the platform comprising at least one of a business data server, a rules processor, a content management server, a business process builder, a report server, a dashboard server, an audit server, and a runtime security server.

16. The method of claim 15, further comprising the step of loading a copy of the deployed dynamic case management application into a tenant runtime environment.

17. The method of claim 15, wherein step (d) further comprises deploying the dynamic case management application into a master tenant within the runtime platform.

18. The method of claim 17, further comprising the step of loading a link to the deployed dynamic case management application into a tenant runtime environment.
